(19) United States
(12) Patent Application Publication
(10) Pub. No.: US 2020/0410620 A1
(43) Pub. Date: Dec. 31, 2020

(54) Dynamic Travel Threat Assessment and Control System

(71) Applicant: Bank of America Corporation, Charlotte, NC (US)

(72) Inventors: Elizabeth R. Liuzzo, Charlotte, NC (US); Edward Lee Traywick, Charlotte, NC (US); Christopher J. Stott, Charlotte, NC (US); Jennifer Walsh, Fort Mill, SC (US); Michael Beveridge, Waxhaw, NC (US); Jeffrey Kyle Johnson, Cornelius, NC (US); Brittney Katrice Spencer, Indian Land, SC (US)

(21) Appl. No.: 16/452,992

(22) Filed: Jun. 26, 2019

(51) Int. Cl. G06Q 50/26; G06Q 10/02; G06Q 50/14; G06N 20/00

(52) U.S. Cl. CPC G06Q 50/265; G06N 20/00; G06Q 50/14; G06Q 10/02

(57) ABSTRACT

Arrangements for dynamical travel threat assessment and control are provided. In some examples, a system may receive a request to schedule travel. The request may include one or more aspects. Based on the aspects, threat data may be requested. The threat data may be requested from a plurality of data sources including internal data sources and external data sources. Machine learning may be used to evaluate the threat data to generate or identify one or more potential threats associated with the requested travel. Based on the generated one or more potential threats, one or more actions may be identified. The actions may include completion criteria used to determine whether an action has been completed. The actions may be transmitted to one or more devices for execution. After executing the actions, action response data may be received and compared to the completion criteria to determine whether the requested travel should be authorized or denied.

### BACKGROUND

Aspects of the disclosure relate to electrical computers, systems, and devices for triggering and executing one or more controls based on a determine travel threat. In particular, one or more aspects of the disclosure relate to dynamic threat assessment and control functions.

Assessing risk associated with travel is important to protecting the safety and security of people and information. Identifying potential threats in a timely, efficient manner is often difficult. In many situations, travel threats are not identified in real-time and, by the time the threat is identified, it may be too late to take steps to mitigate risk associated with the identified threat. Accordingly, it would be advantageous to dynamically assess travel risk and threats and identify actions or controls to implement or execute in order to mitigate the identified risk.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with assessing travel risk and threats.

In some examples, a system may receive a request to schedule travel. The request may include one or more aspects, such as destination, dates of travel, traveler information, purpose of travel, or the like. Based on the aspects, threat data may be requested. The threat data may be requested from a plurality of data sources including internal data sources and external data sources. In some examples, machine learning may be used to evaluate the threat data to generate or identify one or more potential threats associated with the requested travel.

Based on the generated one or more potential threats, one or more actions may be identified. The actions may include completion criteria used to determine whether an action has been completed. In some examples, the actions may be transmitted to one or more devices for execution. After executing the actions, action response data may be received and compared to the completion criteria to determine whether the requested travel should be authorized or denied.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing travel threat assessment and control functions in accordance with one or more aspects described herein;

FIGS. 2A-2G depict an illustrative event sequence for implementing travel threat assessment and control functions in accordance with one or more aspects described herein;

FIG. 3 depicts an illustrative method for implementing and using travel threat assessment and control functions according to one or more aspects described herein;

FIG. 4 illustrates one example user interface for use with travel threat assessment and control functions according to one or more aspects described herein;

FIG. 5 illustrates another example user interface for use with travel threat assessment and control functions according to one or more aspects described herein;

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to dynamic travel threat assessment and control. As discussed above, protecting the safety and security of people and information when traveling is significant. However, understanding potential threats in a timely manner can be difficult or impossible.

Accordingly, as discussed more fully herein, aspects herein are directed to dynamic threat assessment and control. In some examples, upon receiving a request to travel, the requested travel may be evaluated to determine whether the travel will be authorized, whether one or more controls or actions should be implemented prior to, during and/or after travel, and the like. In some examples, machine learning may be used to evaluate aspects of the requested travel and known threat data (e.g., data feeds from internal sources, external sources, and the like). Based on the machine learning evaluation, one or more potential threats may be identified. Based on the potential threats, one or more actions or controls may be identified and/or executed in order to mitigate risk associated with the potential threats. In some examples, the actions or controls may include functions performed prior to the travel, during the travel and/or after travel has been completed.

These and various other arrangements will be discussed more fully below.

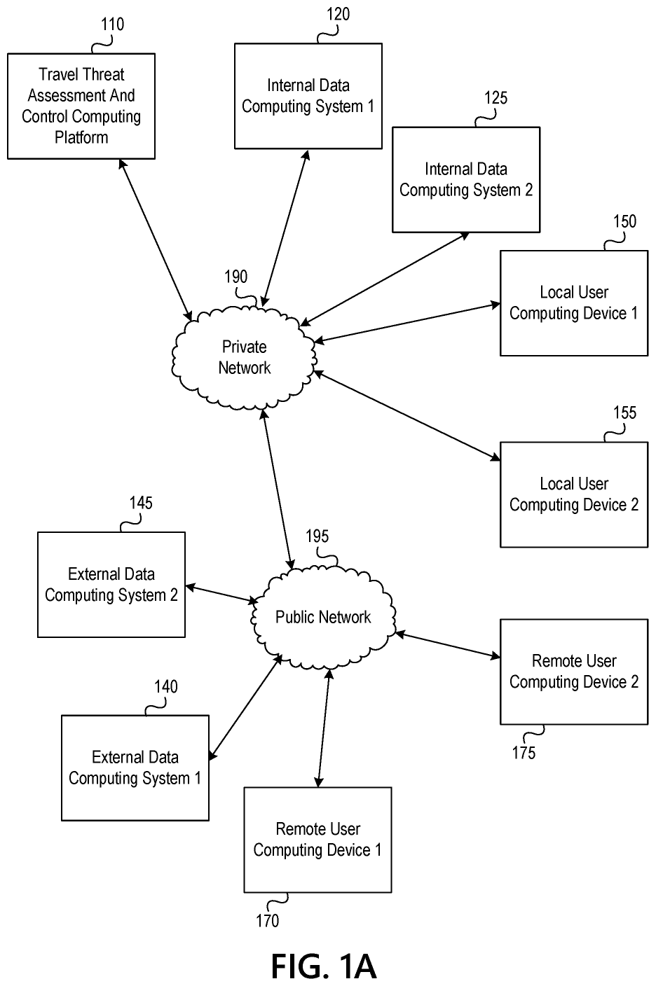

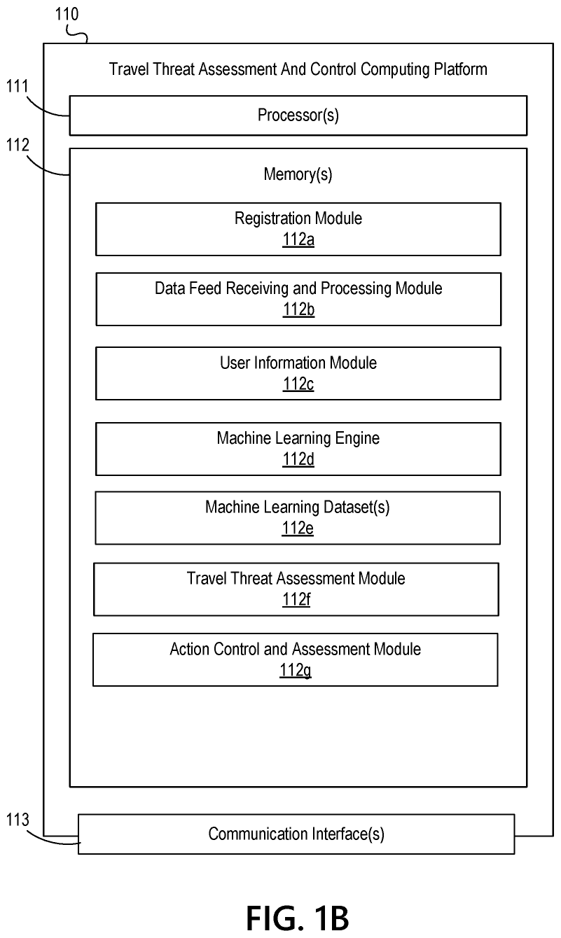

FIGS. 1A and 1B depict an illustrative computing environment for implementing and using a system for travel threat assessment and control in accordance with one or more aspects described herein. Referring to FIG. 1A, computing environment 100 may include one or more computing devices and/or other computing systems. For example, computing environment 100 may include travel threat assessment and control computing platform 110, a first internal data computing system 120, a second internal data computing system 125, a first external data computing system 140, a second external data computing system 145, a first local user computing device 150, a second local user computing device 155, a first remote user computing device 170, and a second remote user computing device 175. Although two internal data computing systems and external data computing systems are shown in FIG. 1A, more or fewer computing systems may be used without departing from the invention.

Travel threat assessment and control computing platform 110 may be configured to provide intelligent, dynamic threat assessment and control. For instance, travel threat assessment and control computing platform may receive data feeds from a plurality of sources. For instance, data from one or more internal data sources (e.g., internal data computing systems 120, 125) that may include user data, traveler data, user preferences, internal threat data, user access data, and the like may be received. Additionally or alternatively, data from one or more external data sources (e.g., external data computing systems 140, 145) that may include external threat data, geographic location and threat data, and the like, may be received. In some examples, the data feeds may be received on a continuous or periodic basis. Additionally or alternatively, the data feeds may be requested in response to receiving a request to schedule travel.

In some examples, travel threat assessment and control computing platform 110 may receive a request to schedule travel. The request may include a name of a user or traveler, dates of travel, location of travel, and the like. In response to receiving the request, the travel threat assessment and control computing platform 110 may analyze the data feeds to assess the threat associated with the travel. For instance, travel to dangerous locations may have an associated threat level. Travel to places with high crime may also have an associated threat level. In addition, threat levels for different geographic locations may vary based on a rule of the user or traveler within an entity. For example, user's having greater access to data or particular types of data may be at greater risk in certain locations than others. Accordingly, machine learning may be used to evaluate the threat data and requested travel to assess the threat level of the particular travel or trip.

Based on the overall threat level, one or more actions or controls may be generated. For instance, the travel threat assessment and control computing platform 110 may generate one or more actions to take to aid in mitigating the risk. For instance, one or more systems accessible via hardware of the user may be disabled to deactivated for the travel dates or period. In another example, alternative hardware may be dispatched to the traveler for the trip. In yet another example, one or more notifications may be generated and provided to the user or traveler identifying potential threats, providing recommendations for maintaining safety while on travel, and the like.

In some examples, threat data and/or other data may be received from one or more computing systems. The computing systems may be internal to the entity implementing the travel threat assessment and control computing platform 110 and/or external to the entity (e.g., publicly available information, information captured by another entity and retrieved with user permissions, and the like). For instance, data may be received from one or more internal data computing systems 120, 125. Internal data computing systems 120, 125 may include or store data associated with previous threats or issues, mitigation strategies for identified threats or issues, user access (e.g., to one or more applications, systems, data, types of data, or the like), hardware associated with one or more users, and the like. External data computing systems 140, 145 may include or store data captured external to the entity and may include previous or identified potential threats, state department travel advisory data, crime statistics associated with one or more geographic locations, and the like. Although two internal data computing systems 120, 125 and two external data computing systems 140, 145 are shown, more or fewer internal and/or external data systems may be used without departing from the invention.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. In some examples, local user computing device 150, 155 may be used to access one or more entity systems, functions or processes. In some examples, local user computing device 150, 155 may be used to access the travel threat assessment and control computing platform 110 to control parameters of the system, update or execute rules, modify settings, display notifications, and the like.

The remote user computing devices 170, 175 may be used to communicate with, for example, travel threat assessment and control computing platform 110. For instance, remote user computing devices 170, 175 may include user computing devices, such as mobile devices including smartphones, tablets, laptop computers, and the like, that may enable or permit a user to communicate with travel threat assessment and control computing platform 110 to input travel requests, receive notifications regarding travel requests, receive notifications of modifications or actions to take associated with a travel request, and the like.

In one or more arrangements, internal data computing system 120, internal data computing system 125, external data computing system 140, external data computing system 145, local user computing device 150, local user computing device 155, remote user computing device 170, and/or remote user computing device 175 may be any type of computing device or combination of devices configured to perform the particular functions described herein. For example, internal data computing system 120, internal data computing system 125, external data computing system 140, external data computing system 145, local user computing device 150, local user computing device 155, remote user computing device 170, and/or remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of internal data computing system 120, internal data computing system 125, external data computing system 140, external data computing system 145, local user computing device 150, local user computing device 155, remote user computing device 170, and/or remote user computing device 175 may, in some instances, be special-purpose computing devices configured to perform specific functions.

Computing environment 100 also may include one or more computing platforms. For example, and as noted above, computing environment 100 may include travel threat assessment and control computing platform 110. As illustrated in greater detail below, travel threat assessment and control computing platform 110 may include one or more computing devices configured to perform one or more of the functions described herein. For example, travel threat assessment and control computing platform 110 may include one or more computers (e.g., laptop computers, desktop computers, servers, server blades, or the like).

As mentioned above, computing environment 100 also may include one or more networks, which may interconnect one or more of travel threat assessment and control computing platform 110, internal data computing system 120, internal data computing system 125, external data computing system 140, external data computing system 145, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, travel threat assessment and control computing platform 110, internal data computing system 120, internal data computing system 125, local user computing device 150, and local user computing device 155, may be associated with an organization (e.g., a financial institution), and private network 190 may be associated with and/or operated by the organization, and may include one or more networks (e.g., LANs, WANs, virtual private networks (VPNs), or the like) that interconnect travel threat assessment and control computing platform 110, internal data computing system 120, internal data computing system 125, local user computing device 150, local user computing device 155, and one or more other computing devices and/or computer systems that are used by, operated by, and/or otherwise associated with the organization. Public network 195 may connect private network 190 and/or one or more computing devices connected thereto (e.g., travel threat assessment and control computing platform 110, internal data computing system 120, internal data computing system 125, local user computing device 150, local user computing device 155) with one or more networks and/or computing devices that are not associated with the organization. For example, external data computing system 140, external data computing system 145, remote user computing device 170, remote user computing device 175, might not be associated with an organization that operates private network 190 (e.g., because external data computing system 140, external data computing system 145, remote user computing device 170, remote user computing device 175, may be owned, operated, and/or serviced by one or more entities different from the organization that operates private network 190, such as a second entity different from the entity, one or more customers of the organization, one or more employees of the organization, public or government entities, and/or vendors of the organization, rather than being owned and/or operated by the organization itself), and public network 195 may include one or more networks (e.g., the internet) that connect external data computing system 140, external data computing system 145, remote user computing device 170, remote user computing device 175, to private network 190 and/or one or more computing devices connected thereto (e.g., travel threat assessment and control computing platform 110, internal data computing system 120, internal data computing system 125, local user computing device 150, local user computing device 155).

Referring to FIG. 1B, travel threat assessment and control computing platform 110 may include one or more processors 111, memory 112, and communication interface 113. A data bus may interconnect processor(s) 111, memory 112, and communication interface 113. Communication interface 113 may be a network interface configured to support communication between travel threat assessment and control computing platform 110 and one or more networks (e.g., private network 190, public network 195, or the like). Memory 112 may include one or more program modules having instructions that when executed by processor(s) 111 cause travel threat assessment and control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of travel threat assessment and control computing platform 110 and/or by different computing devices that may form and/or otherwise make up travel threat assessment and control computing platform 110.

For example, memory 112 may have, store and/or include a registration module 112a. Registration module 112a may store instructions and/or data that may cause or enable the travel threat assessment and control computing platform 110 to receive registration information for one or more users. For instance, individual users may register with the system and provide user information, such as name, contact information, passport number, travel preferences, and the like. Additionally or alternatively, an entity may register some or all employees in a registration process (e.g., user data may be extracted from one or more databases and transmitted to the travel threat assessment and control computing platform 110 for registration).

The registration data may be received by the registration module 112a and a registration record may be generated. The registration record may be generated in a data structure and adding the record may modify the data structure. The registration information may then be stored and may be used to assess travel risk, evaluate travel requests, generate actions, and the like.

Travel threat assessment and control computing platform 110 may further have, store and/or include a data feed receiving and processing module 112b. Data feed receiving and processing module 112b may store instructions and/or data that may cause or enable the travel threat assessment and control computing platform 110 to receiving data from one or more data sources, such as internal data computing system 120, internal data computing system 125, external data computing system 140, external data computing system 145, and the like. The data may be related to users, travel threats or potential threats in one or more geographic locations, access to particular users, identified threats, potential threats or types of threats (e.g., cyberattacks, or the like), and the like. The data may be received from one or more data sources in a data feed, at predetermined times, continuously, or the like. In some examples, the received data may be stored and/or formatted for further processing. For instance, in some examples, data may be formatted to convert the received data from a first data type or format to a second data type or format to enable aggregation of data, processing of data, comparison of data, and the like.

Travel threat assessment and control computing platform 110 may further have, store and/or include a user information module 112c. User information module 112c may store instructions and/or data that may cause or enable the travel threat assessment and control computing platform 110 to receive and store data associated with one or more users. For instance, user data including contact information, hardware associated with a user, access levels, and the like, may be stored for each user registered with the system. The data may be received from one or more sources (e.g., from internal data computing system 120, internal data computing system 125, or the like) and/or may be input by a user, administrator, or the like.

In some examples, user information module 112c may further include data associated with a request for travel received from a particular user. For instance, a request for travel may include destination information, dates of travel, intervening stops, user role, purpose of travel, and the like. This data may be used to assess travel threats and generate actions.

In some examples, machine learning may be used to evaluate the received data in order to predict a likely threat for a particular trip, particular geographic location, and the like, and/or to identify one or more actions for completion. Accordingly, travel threat assessment and control computing platform 110 may have, store and/or include a machine learning engine 112d and machine learning datasets 112e. Machine learning engine 112d and machine learning datasets 112e may store instructions and/or data that may cause or enable travel threat assessment and control computing platform 110 to further process data from, for example, data feed receiving and processing module 112b, user information module 112c, one or more data sources (e.g., internal data computing system 120, internal data computing system 125, external data computing system 140, external data computing system 145), and the like, to identify one or more patterns or predictions associated with potential travel threats (e.g., threats associated with geographical location, threat associated with venue, threat associated with type of travel or purpose of travel, and the like). For instance, based on the received (and/or processed) data, the machine learning engine 112d may generate predictions associated with potential threats for a particular requested travel (e.g., destination, dates, times, purpose, and the like). The machine learning datasets 112e may be generated based on analyzed data (e.g., data from previously received data, known threats and mitigation actions, and the like), raw data, and/or received from one or more outside sources.

The machine learning engine 112d may receive data related to one or more users, locations, potential threats, and the like, and, using one or more machine learning algorithms, may generate one or more machine learning datasets 112e. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention. In some examples, the machine learning engine 112d may analyze data to identify patterns of activity, sequences of activity, and the like, to generate one or more machine learning datasets 112e.

In some examples, the machine learning datasets 112e may include machine learning data linking one or more threats, potential threats, geographic locations, dates of travel, or the like, to requested travel and actions to take in order to mitigate risk associated with the identified threat or potential threat. For instance, the analyzed data may predict a potential threat or type of threat, likelihood of threat, and identify one or more actions to perform or execute in order to mitigate risk associated with the threat.

Based on the generated machine learning datasets 112e, travel threat assessment module 112f may generate a travel threat assessment associated with requested travel. For instance, travel threat assessment module 112f may store instructions and/or data that may cause or enable the travel threat assessment and control computing platform 110 to evaluate requested travel, capture generated threat predictions, generate one or more notifications associated with the threat predictions, send and display notifications, and the like.

Travel threat assessment and control computing platform 110 may further have, store and/or include action control and assessment module 112g. Action control and assessment module 112g may store instructions and/or data that may cause or enable the travel threat assessment and control computing platform 110 to, based on the machine learning analysis, generate one or more actions or action items to perform, execute, or complete related to the requested travel. For instance, the system may generate a plurality of actions, including modifying access to one or more systems or data types, modifying or exchanging hardware prior to travel, identifying forms for completion and/or additional steps (e.g., immunizations, or the like), identifying mitigating actions to take before and/or during travel (e.g., avoid certain locations within the destination, contact information for local law enforcement, US embassies, or the like), and the like. In some examples, modification of internal systems, access and the like, may be performed by the action control and assessment module 112g and/or may be transmitted to one or more internal data computing systems 120, 125 for execution.

In some examples, action response data may be received in response to the generated actions. The user response data may be received from one or more systems, computing devices, users, or the like. In some arrangements, the action response data may be compared to completion criteria associated with each generated action. If all or at least a predetermined number of completion criteria for a particular action are completed based on the action response data, the action may be marked completed or closed. When at least a threshold number of actions are completed or closed, the requested travel may be approved and the requested travel may be released for booking.

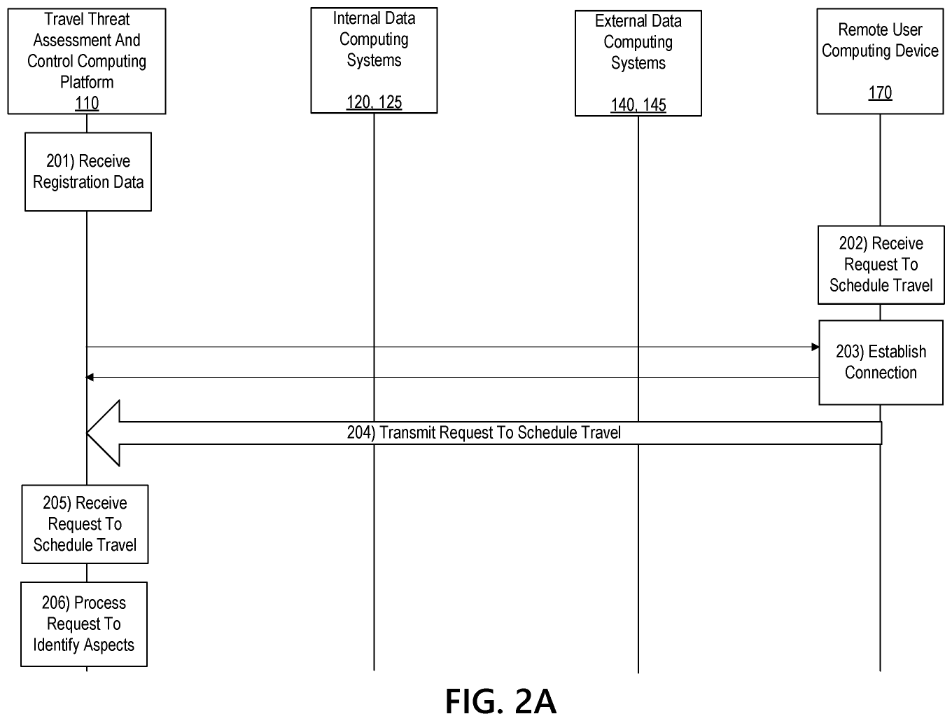

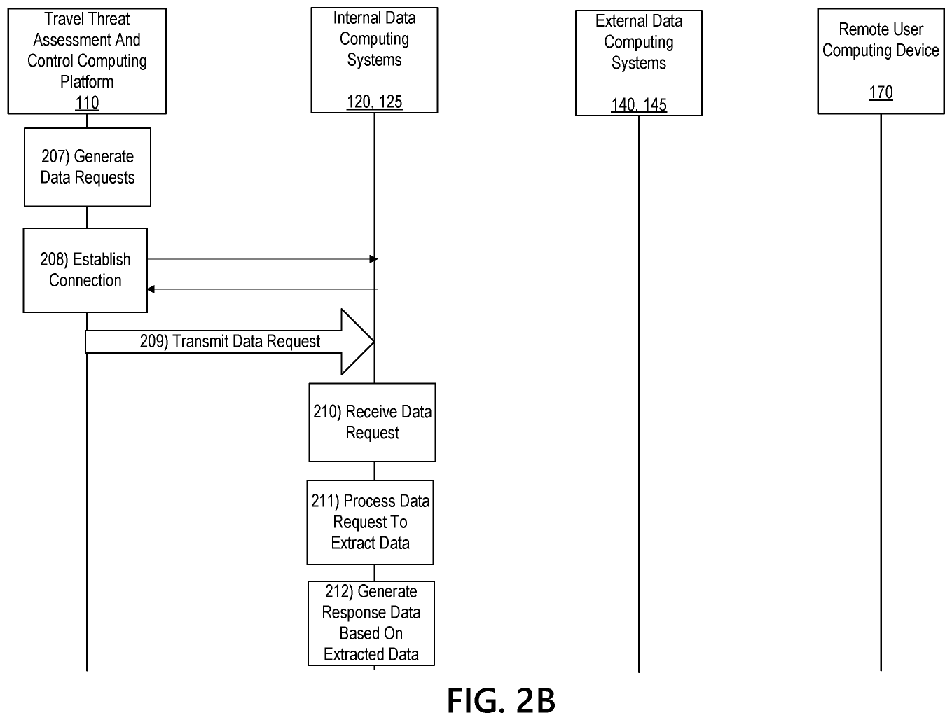

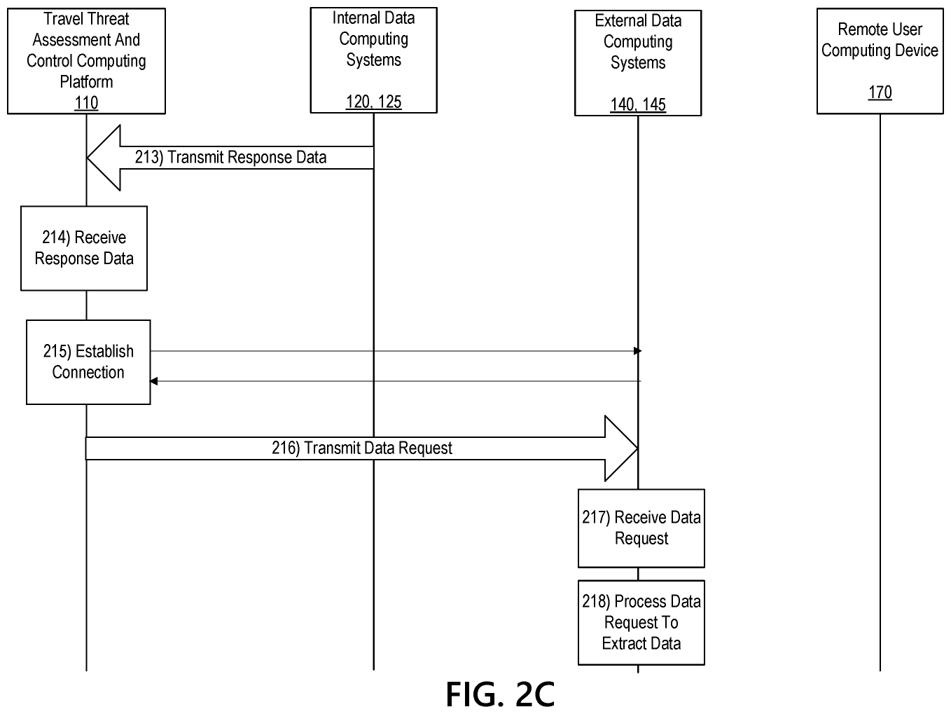

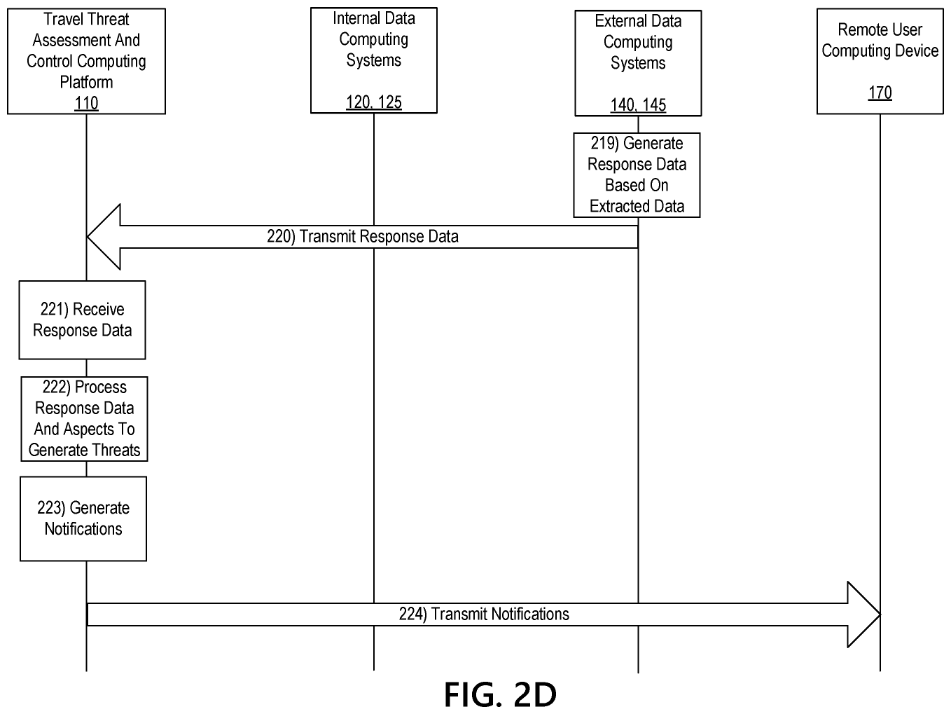

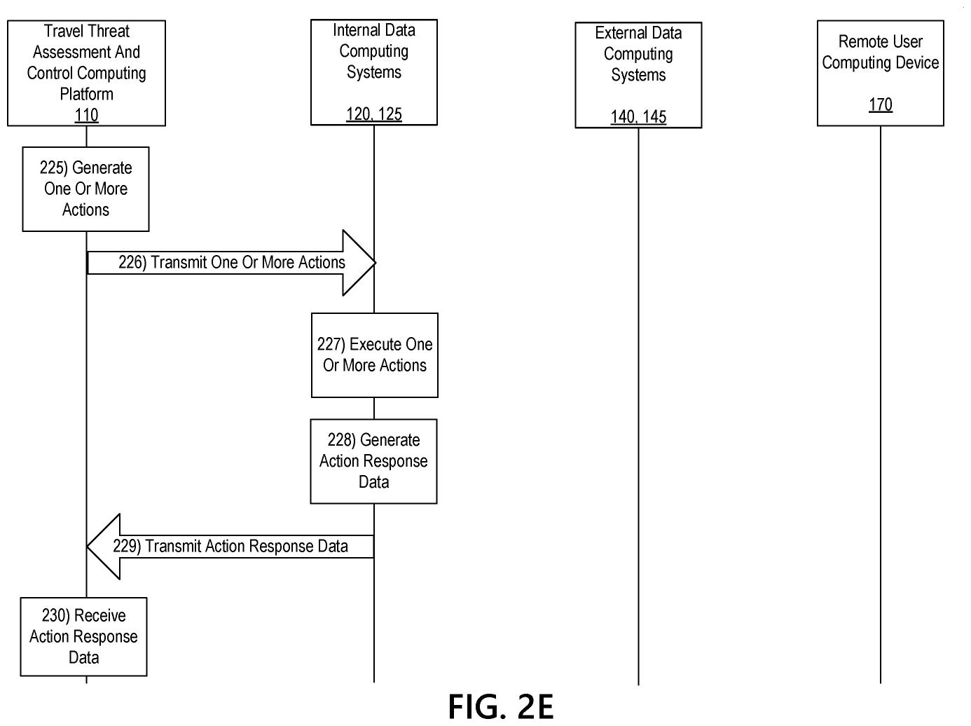

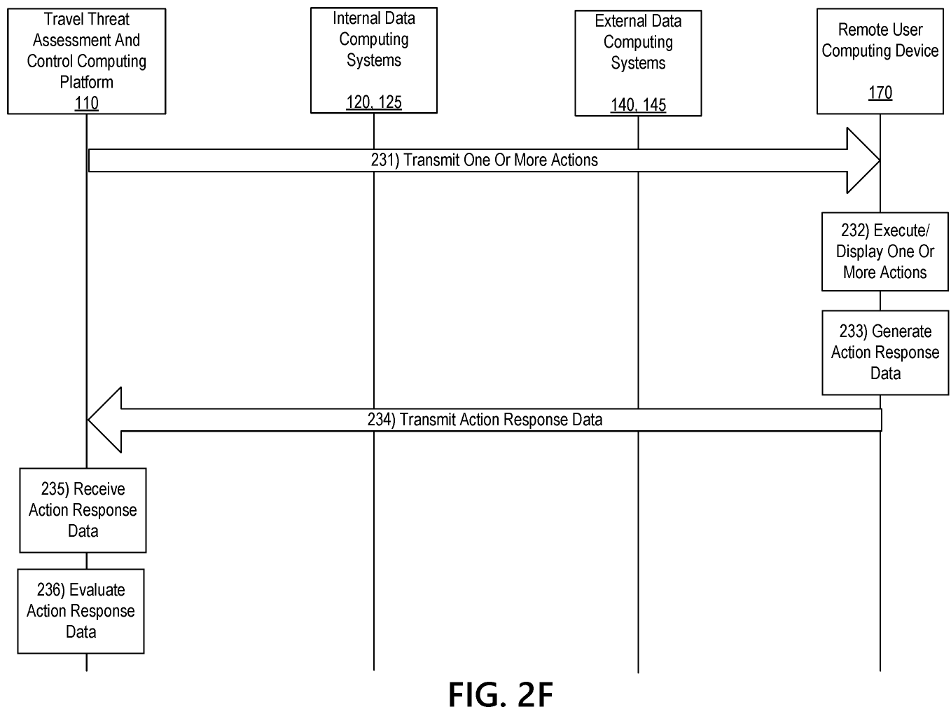

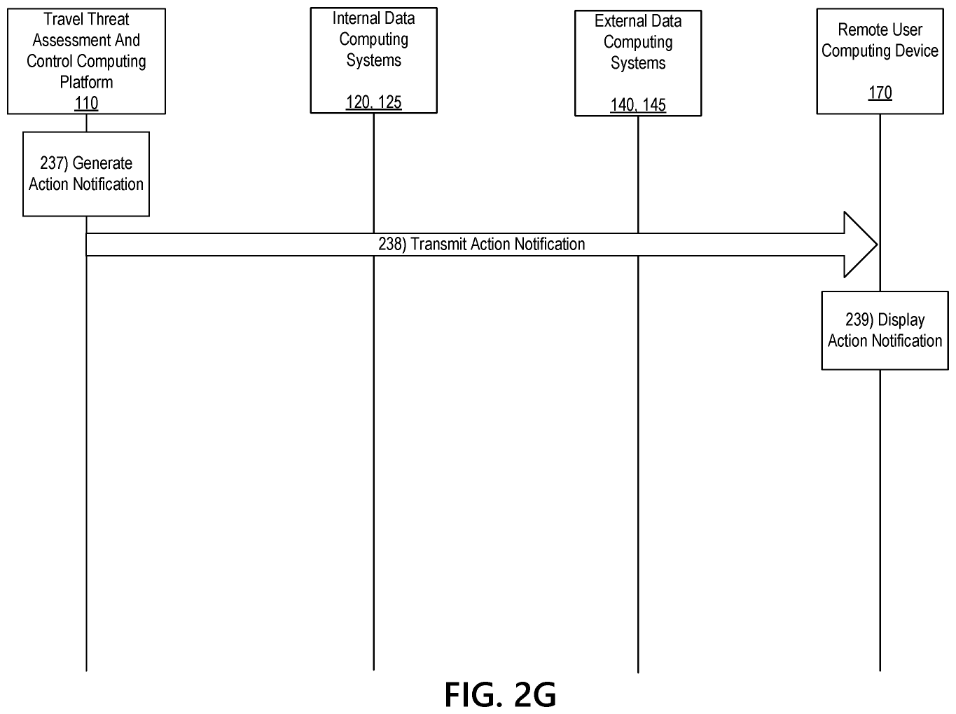

FIGS. 2A-2G depict one example illustrative event sequence for implementing and using dynamic travel threat assessment and control in accordance with one or more aspects described herein. The events shown in the illustrative event sequence are merely one example sequence and additional events may be added, or events may be omitted, without departing from the invention.

Referring to FIG. 2A, at step 201, registration data may be received. In some examples, registration data may include receiving user data associated with one or more users or employees of an entity implementing the travel threat assessment and control computing platform 110. For instance, any user or employee who may travel for the entity may register with the system. The data may be received from the user or employee directly or from one or more systems of the entity (e.g., internal data computing systems 120, 125). In some examples, the registration data may include names, contact information, travel preferences, role within the entity, access information, and the like.

At step 202, a request for travel may be received. For instance, a request to schedule or reserve travel may be received from a user via, for example, remote user computing device 170. In some examples, the request to travel may include destination information, dates of travel, purpose of travel, and the like. In some arrangements, the request to travel may be received via an application received by the remote user computing device 170 and executing on the remote user computing device.

Responsive to receiving the request to travel, at step 203, a connection may be established between the travel threat assessment and control computing platform 110 and remote user computing device 170. For instance, a first wireless connection may be established between the remote user computing device 170 and the travel threat assessment and control computing platform 110. Upon establishing the first wireless connection, a communication session may be initiated between the remote user computing device 170 and the travel threat assessment and control computing platform 110.

At step 204, the request for travel may be transmitted from the remote user computing device 170 to the travel threat assessment and control computing platform 110. For instance, the request for travel may be transmitted during the communication session established upon initiating the first wireless connection.

At step 205, the request for travel may be received by the travel threat assessment and control computing platform 110. At step 206, the received request for travel may be processed. In some examples, processing the request for travel may include extracting data to identify aspects of the requested travel. For instance, the request may be processed to identify aspects such as destination, dates, purpose, and the like.

With reference to FIG. 2B, at step 207, one or more data requests may be generated. For instance, requests for data, such as threat data, associated with the destination, travel dates, purpose of travel, and the like, may be requested. In some examples, the requested data may include potential threats, historical threat data, actions taken to mitigate a threat, and the like. The data requests may include the aspects identified from the request for travel for use as input into a query to extract the desired data. In some examples, the data requested may be received and stored by the travel threat assessment and control computing platform 110. Additionally or alternatively, the travel threat assessment and control computing platform 110 may request current threat data upon receiving a request for travel and may analyze the current data.

At step 208, a connection may be established between the travel threat assessment and control computing platform 110 and one or more internal data computing systems 120, 125. For instance, a second wireless connection may be established between the travel threat assessment and control computing platform 110 and the one or more internal data computing systems 120, 125. Upon establishing the second wireless connection, a communication session may be initiated between the one or more internal data computing systems 120, 125 and the travel threat assessment and control computing platform 110.

At step 209, a generated data request may be transmitted from the travel threat assessment and control computing platform 110 to the one or more internal data computing systems 120, 125. For instance, the generated data request may be transmitted during the communication session initiated upon establishing the second wireless connection.

At step 210, the generated data request may be received by the one or more internal data computing systems 120, 125. At step 211, the received data request may be processed by the one or more internal data computing systems 120, 125 to extract the requested data. For instance, the one or more aspects may be used as input into a query to extract the requested data.

At step 212, response data may be generated based on the extracted data.

With reference to FIG. 2C, at step 213, the generated response data may be transmitted from the one or more internal data computing systems 120, 125 to the travel threat assessment and control computing platform 110. At step 214, the response data may be received by the travel threat assessment and control computing platform 110.

At step 215, a connection may be established between the travel threat assessment and control computing platform 110 and one or more external data computing systems 140, 145. For instance, a third wireless connection may be established between the travel threat assessment and control computing platform 110 and the one or more external data computing systems 140, 145. Upon establishing the third wireless connection, a communication session may be initiated between the one or more external data computing systems 140, 145 and the travel threat assessment and control computing platform 110.

At step 216, a generated data request may be transmitted from the travel threat assessment and control computing platform 110 to the one or more external data computing systems 140, 145. For instance, the generated data request may be transmitted during the communication session initiated upon establishing the third wireless connection.

At step 217, the generated data request may be received by the one or more external data computing systems 140, 145. At step 218, the received data request may be processed by the one or more external data computing systems 140, 145 to extract the requested data. For instance, the one or more aspects may be used as input into a query to extract the requested data.

With reference to FIG. 2D, at step 219, response data may be generated based on the extracted data.

At step 220, the generated response data may be transmitted from the one or more external data computing systems 140, 145 to the travel threat assessment and control computing platform 110. At step 221, the response data may be received by the travel threat assessment and control computing platform 110.

At step 222, the received response data and identified aspects may be processed to identify one or more travel threats associated with the requested travel. For instance, machine learning may be used to identify patterns, sequences, and the like, within the response data and aspects to identify one or more threats or potential threats associated with the requested travel. For instance, threats may include identified threats or potential threats associated with a particular geographic location (e.g., destination, location near a destination, or the like). In another example, threats may include threats associated with a purpose of travel (e.g., a particular conference or gathering). The threats may include physical threats, cyber threats, or the like.

At step 223, one or more notifications including the identified threats or potential threats may be generated. The notifications may include a type of threat, location of threat, and the like. At step 224, the one or more notifications may be transmitted to, for instance, remote user computing device 170 and displayed on the remote user computing device 170.

With reference to FIG. 2E, at step 225, one or more actions may be generated. For instance, based on the analyzed response data and aspects, one or more actions to mitigate the identified risks may be generated. In some examples, machine learning may be used to generate the one or more actions. In some arrangements, the one or more actions may include generate and transmitting one or more notifications to a user to indicate potential threats, provide recommendations for maintaining safety and security, and the like. The notifications may be particular to the user, destination, purpose of travel, or the like. Additionally or alternatively, the one or more actions may include enhanced security controls. For instance, performing additional malware scans of hardware associated with the traveler, locking down particular devices or applications during the travel period, modifying access to one or more systems, data, or the like, for the traveler during the travel period, performing post-trip processing to ensure hardware and software security intact and update or validate machine learning datasets, and the like.

At step 226, one or more of the generated one or more actions may be transmitted to one or more internal data computing systems 120, 125. At step 227, the transmitted one or more actions may be executed by the internal data computing systems 120, 125. For instance, executing one or more malware scans, modifying access to systems or data, locking down devices or applications, or the like, may be executed by the internal data computing systems 120, 125.

After executing the one or more actions, action response data may be generated at step 228. The action response data may include data associated with actions executed, results of any executed actions (e.g., results of malware scans), and the like. At step 229, the action response data may be transmitted from the internal data computing systems 120, 125 to the travel threat assessment and control computing platform 110. At step 230, the action response data may be received by the travel threat assessment and control computing platform 110.

With reference to FIG. 2F, at step 231, one or more of the generated one or more actions may be transmitted to the remote user computing device 170. For instance, actions including notifications of recommendations for mitigating risk, actions modifying the remote user computing device 170 (e.g., modifying access, application availability, or the like), and/or notifications associated with actions executed by the internal data computing systems 120, 125 may be transmitted to the remote user computing device 170.

At step 232, the one or more actions may be executed by the remote user computing device 170 and/or displayed by the remote user computing device 170. After executing and/or displaying the one or more actions, action response data may be generated by the remote user computing device 170 at step 233. The action response data may include data associated with actions executed by the remote user computing device 170. At step 234, the generated action response data may be transmitted to the travel threat assessment and control computing platform 110.

At step 235, the action response data may be received by the travel threat assessment and control computing platform 110. At step 236, the received action response data (e.g., from the internal data computing systems 120, 125, from remote user computing device 170, and the like) may be evaluated. For instance, completion criteria associated with each action may be compared to the received response data. If at least a threshold number of completion criteria for a particular action is completed (e.g., based on the received response data) the action may be flagged as completed. Upon determining that at least a threshold number of actions have been completed, the requested travel may be approved for booking. In some examples, one or more actions may be required to be completed prior to booking. For instance, some actions may be identified as having a higher importance than other actions and completion of those actions may be required prior to approving the requested travel for booking.

With reference to FIG. 2G, at step 237, an action notification may be generated. The action notification may include information associated with whether a sufficient number of actions were completed, whether any required actions were completed, and the like. The action notification may further include an indication of whether the requested travel is approved for booking or denied. In some examples, completion of any required actions or a sufficient number of actions may cause automatic booking of the requested travel and the action notification may include an indication that the requested travel has been booked.

At step 238, the generated action notification may be transmitted to the remote user computing device 170. At step 239, the action notification may be displayed on a display of the remote user computing device 170.

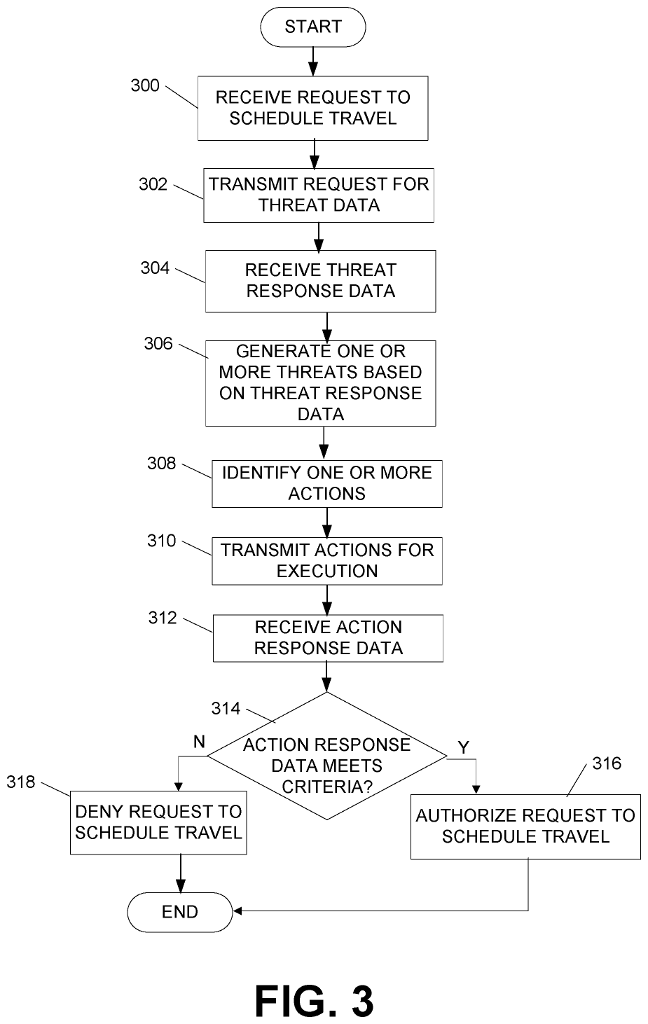

FIG. 3 is a flow chart illustrating one example method of dynamic travel threat assessment and control according to one or more aspects described herein. The processes illustrated in FIG. 3 are merely some example processes and functions. The steps shown may be performed in the order shown, in a different order, more steps may be added, or one or more steps may be omitted, without departing from the invention.

At step 300, a request to schedule travel may be received. For instance, a request to schedule travel may be received by the travel threat assessment and control computing platform 110 from a user computing device, such as remote user computing device 170. The request to schedule travel may include aspects such as destination, dates of travel, purpose of travel, traveler information, and the like.

At step 302, in response to receiving the request to schedule travel, requests for threat data may be generated. In some examples, the aspects of travel received with the request may be used to define parameters of the requested threat data. The generated requests may be transmitted to one or more computing devices, such as internal data computing systems 120, 125, external data computing systems 140, 145, and the like.

In response to the requests for threat data, threat response data may be generated by the computing devices or systems, transmitted to the travel threat assessment and control computing platform 110 and received by the travel threat assessment and control computing platform 110 at step 304. The threat response data may include actual or potential threats associated with various geographic locations at or near the destination, physical threats, cyber threats, crime statistics or notices, or the like.

At step 306, based on the threat response data and the aspects of the requested travel, machine learning may be used to generate one or more potential threats for the requested travel. The generated threats may include threats particular to the traveler (e.g., based on traveler's position within the entity or other features of the traveler), particular to the dates of travel, particular to the purpose of travel, or the like.

At step 308, based on the generated one or more potential threats, one or more actions may be generated. The actions may include items for completion prior to authorizing the requested travel for booking. In some examples, at least a threshold number (e.g., fewer than all) actions must be completed before approval for travel. In other examples, all identified actions must be completed prior to authorizing the requested travel. In some examples, one or more actions may be more heavily weighted than others (e.g., may be prioritized or have greater significance). In those examples, actions having a higher priority or weight may be required for completion prior to approval of travel (e.g., even if fewer than all actions must be completed, at least those prioritized actions must be completed).

In some examples, each action may include a plurality of completion criteria used to determine whether the action has been completed. In some examples, at least a threshold number of criteria (e.g., fewer than all) of the completion criteria must be completed prior to considering the action completed. In other examples, all completion criteria for an action must be completed in order to identify or flag the action as completed.

At step 310, the one or more actions may be transmitted to one or more computing devices for execution. For instance, some or all of the one or more actions may be transmitted to internal data computing systems 120, 125 for execution. Additionally or alternatively, some or all of the one or more actions may be transmitted to the remote user computing device 170 for completion.

After executing the actions, the computing devices may generated actions response data that may be transmitted to and received by the travel threat assessment and control computing platform 110 at step 312.

At step 314, a determination may be made as to whether the action response data meets the completion criteria for the one or more actions. For instance, the action response data may be compared to the completion criteria for each action to determine whether at least a threshold number of criteria are complete, whether at least a threshold number of actions are completed, and the like. If so, the request to schedule travel may be authorized at step 316. In some examples, authorizing the request to schedule travel may include automatically scheduling the requested travel.

If, at step 314, the action response data does not meet the completion criteria for the one or more actions, the requested travel may be denied at step 318.

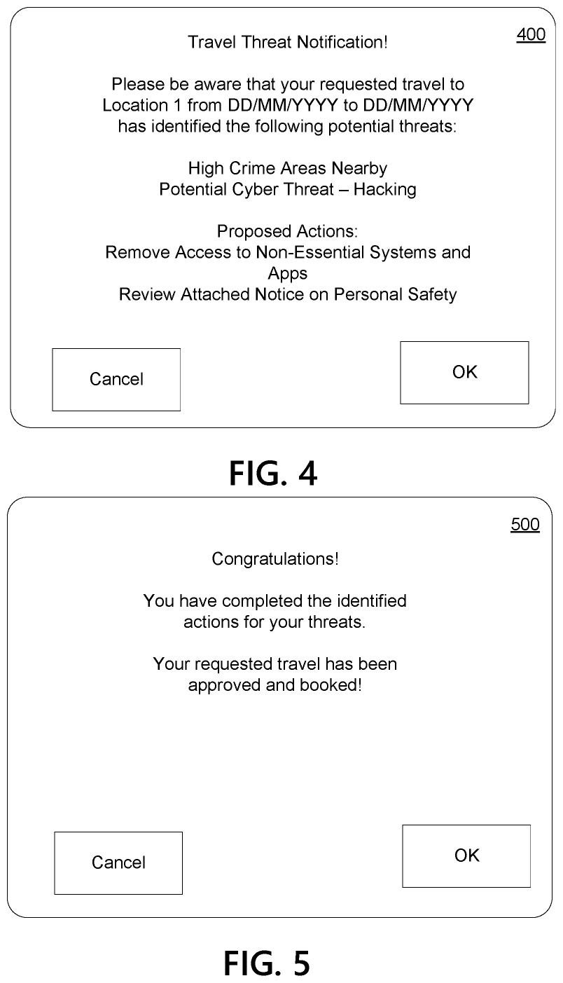

FIG. 4 illustrates one example user interface that may be used in accordance with the dynamic travel threat assessment and control functions described herein. The user interface 400 includes identification of one or more threats generated based on threat response data, aspects of requested travel, and the like. In addition, the user interface include identification of one or more actions to be completed to authorized travel. In some examples, the actions may be automatically executed by one or more computing devices or systems. In other examples, a user may be required to view notifications, pamphlets or the like, and acknowledge that they have read them (e.g., review the notice on personal safety).

FIG. 5 illustrates another example user interface that may be used in accordance with the dynamic travel threat assessment and control functions described herein. The user interface 500 includes an indication that all (or at least a threshold number (e.g., a predetermined number that is less than all)) actions identified have been completed. The interface 500 further includes an indication that the requested travel has been approved and, in this example, automatically booked or scheduled.

Aspects described herein relate to dynamic travel threat assessment and controls. For instance, as discussed herein, a user may request travel or scheduling of travel. The request may include one or more aspects, such as destination, dates of travel, traveler information, purpose of travel, and the like. Based on the aspects, machine learning may be used to evaluate risk associated with the requested travel. The machine learning may analyzed threat data from a plurality of sources, as well as aspects of the requested travel, to identify or generate one or more potential threats. Based on the identified one or more potential threats, a plurality of actions or controls may be identified. The actions or controls may be executed and, upon completion, the requested travel may be authorized or denied.

Aspects described herein may be useful to large enterprise organizations who may have employees or other users traveling to various locations. The arrangements described herein provide for evaluation of threat data in real-time (e.g., at the time of requesting travel) in order to understand and evaluate the most current risks. Further, after travel is authorized, risk or threat data may be continuously or periodically analyzed to identify any new threats or risks that may arise after the initial evaluation of the requested travel. Accordingly, any risk or threat associated with the travel may be evaluated and identified on an ongoing basis until completion of the travel.

Further, the arrangements described herein provide for travel threat assessment that is customized to a particular user, destination, purpose, or the like. By evaluating threat data from a plurality of sources in real-time or near real-time, risks can be evaluated with respect to a plurality of distinct factors associated with a particular trip, user, destination, or the like. For instance, a user travel history, personal aspects, or the like, may be identified and used to evaluate potential threats or risks. For example, factors such as a level of security clearance of the user, position within the entity the traveler is representing, credit rating, or other factors may be considered and evaluated (e.g., via machine learning) when identifying threats associated with a potential trip and/or identifying actions or controls.

Further, particular dates at the destination may be considered to identify potential threats that may exist at certain times or dates but not at others. In another example, a purpose of a trip may be considered such that, if a large conference is occurring, the threat associated with a target of that nature may be considered when scheduling the trip.

As discussed herein, aspects described relate to evaluating travel threat or risk associated with people travelling, as well as information. For instance, the arrangements described herein may be used to mitigate risk associated with the personal safety of the traveler, as well as information security during the trip. In some examples, threat data and evaluation thereof may consider a likelihood of cyber threats. For instance, the system may evaluate crime rates at a destination. Those crime rates may impact a likelihood of theft (e.g., theft of hardware for the hardware itself) but may not consider the likelihood of theft of hardware for the information contained on the hardware. That evaluation may be based on factors associated with cyber crime initiated in an area or experienced in an area. This data may be evaluated, via machine learning, to determine potential threats of theft of either type.

As discussed herein, one or more actions or controls may be identified and/or executed in order to mitigate risk associated with the requested travel. For instance, one or more notifications or pamphlets may be generated or provided to a user for consideration prior to, during and/or after travel. For instance, information associated with maintaining safety and security of the person and information may be contained in the notification and the user may be provided with the notification in advance of and during the trip to implement the recommended processes to ensure safety and security.

In another example, modifications to hardware and/or software may be executed as an action or control. For instance, an alternate piece of hardware (e.g., laptop, smartphone, or the like) may be provided to the user for use during the trip to avoid loss of data or hardware contained on the user's standard hardware. In another example, access to one or more systems, applications, or the like, may be modified during the trip in order to reduce risk of unauthorized access to the systems and/or applications. In some examples, a malware scan may be performed prior to leaving for the trip and after the trip occurred to understand any potential malware threats on a device. In some examples, enhanced monitoring of one or more devices of the user may be performed for a predefined period after completion of the trip to identify any potential issues.

In some examples, data from one or more devices and/or users may be captured after a trip to update and/or validate one or more machine learning datasets. For instance, data associated with whether any identified threats materialized, whether recommended actions mitigated the risk associated with the threats, and the like, may be captured and used to update and/or validate the machine learning datasets.

As discussed herein, an initial evaluation of travel threat may be triggered upon requesting travel. However, in some examples, other triggering events may prompt evaluation of travel threat. For instance, as discussed herein, threats may be evaluated on an ongoing basis from the date travel is requested through completion of the trip to identify any new threats. In another example, if a change or modification is made to a pre-planned trip or itinerary, this may trigger another evaluation of risk associated with the travel.

In yet another example, use of a corporate credit card may prompt evaluation of threat. For instance, if a user uses his or her corporate credit card at a destination, the system may automatically initiate an assessment of threat associated with the destination and may communicate any actions or controls to the user, execute actions or controls by one or more devices, or the like.

Initiation of a travel threat assessment may be performed based on data received from a plurality of different channels. For instance, a user may request and/or modify travel via an online booking system. This may trigger the threat evaluation. In another example, the user may call a service to modify or book travel. The booking via the phone system may also trigger evaluation of the threat. Accordingly, the travel threat assessment system may be integrated with a variety of systems to ensure that all potential travel threats are evaluated promptly.

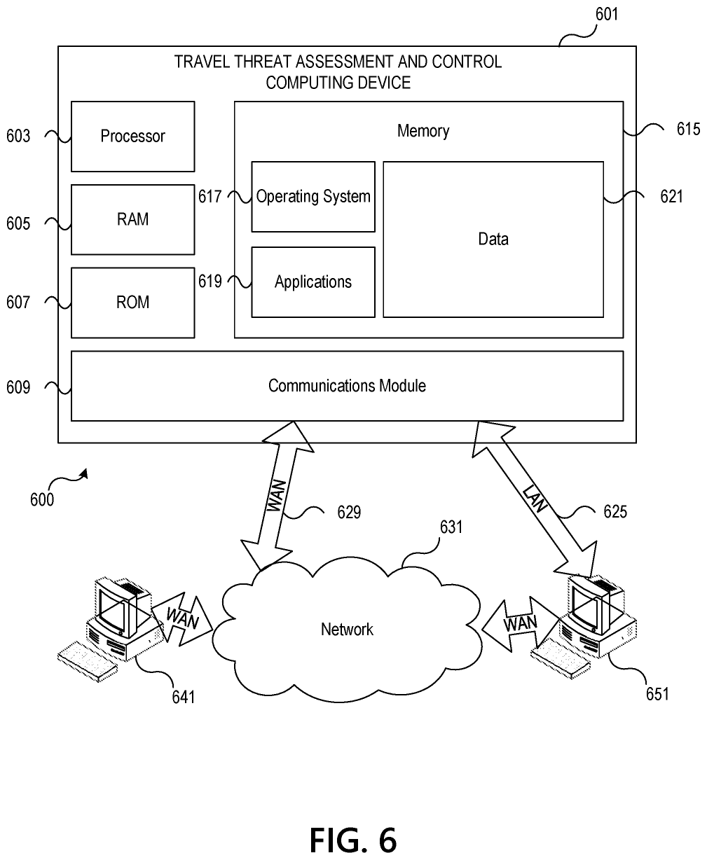

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include travel threat assessment and control computing device 601 having processor 603 for controlling overall operation of travel threat assessment and control computing device 601 and its associated components, including Random Access Memory (RAM) 605, Read-Only Memory (ROM) 607, communications module 609, and memory 615. Travel threat assessment and control computing device 601 may include a variety of computer readable media. Computer readable media may be any available media that may be accessed by travel threat assessment and control computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by travel threat assessment and control computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on travel threat assessment and control computing device 601. Such a processor may execute computer-executable instructions stored on a computer-readable medium.

Software may be stored within memory 615 and/or storage to provide instructions to processor 603 for enabling travel threat assessment and control computing device 601 to perform various functions as discussed herein. For example, memory 615 may store software used by travel threat assessment and control computing device 601, such as operating system 617, application programs 619, and associated database 621. Also, some or all of the computer executable instructions for travel threat assessment and control computing device 601 may be embodied in hardware or firmware. Although not shown, RAM 605 may include one or more applications representing the application data stored in RAM 605 while travel threat assessment and control computing device 601 is on and corresponding software applications (e.g., software tasks) are running on travel threat assessment and control computing device 601.

Communications module 609 may include a microphone, keypad, touch screen, and/or stylus through which a user of travel threat assessment and control computing device 601 may provide input, and may also include one or more of a speaker for providing audio output and a video display device for providing textual, audiovisual and/or graphical output. Computing system environment 600 may also include optical scanners (not shown).

Travel threat assessment and control computing device 601 may operate in a networked environment supporting connections to one or more remote computing devices, such as computing devices 641 and 651. Computing devices 641 and 651 may be personal computing devices or servers that include any or all of the elements described above relative to travel threat assessment and control computing device 601.

The network connections depicted in FIG. 6 may include Local Area Network (LAN) 625 and Wide Area Network (WAN) 629, as well as other networks. When used in a LAN networking environment, travel threat assessment and control computing device 601 may be connected to LAN 625 through a network interface or adapter in communications module 609. When used in a WAN networking environment, travel threat assessment and control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

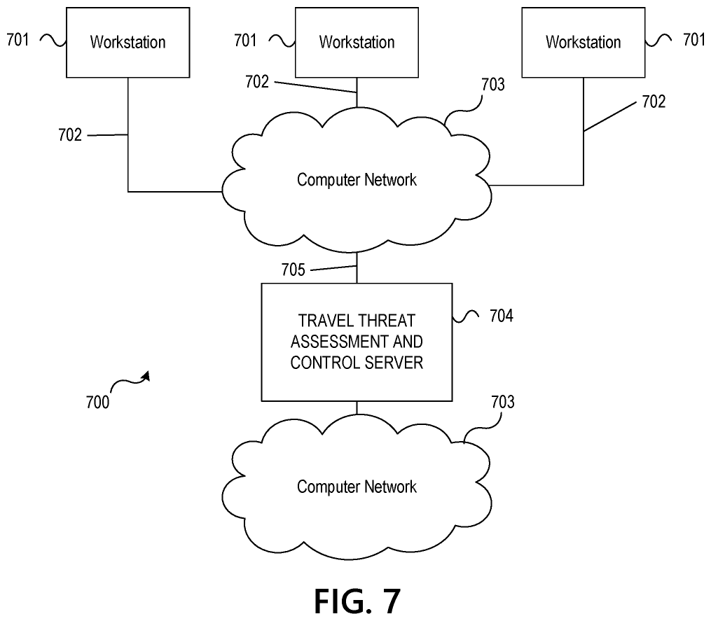

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to travel threat assessment and control server 704. In system 700, travel threat assessment and control server 704 may be a server, processor, computer, or data processing device, or combination of the same, configured to perform the functions and/or processes described herein. Server 704 may be used to receive requests for travel, receive and process threat response data, generate one or more threats or potential threats, identify actions, determine whether actions have been completed, authorize or deny requested travel, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and travel threat assessment and control server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive a request to schedule travel, the request including a destination, dates of travel, and traveler data;
request, from a plurality of data sources, threat data, the requested threat data including data related to at least one of: the destination, dates of travel and traveler;
responsive to requesting the threat data, receive, from the plurality of data sources, threat response data;
based on the received threat response data, the destination, dates of travel and traveler data, and using on one or more machine learning datasets, generate one or more potential threats;
based on the generated one or more potential threats, identify one or more actions for completion, each action of the one or more actions including a plurality of completion criteria;
transmit the one or more actions to one or more devices for execution;
receive, from the one or more devices, action response data including data associated with execution of the one or more actions;
compare the action response data to the completion criteria for each action of the one or more actions;
responsive to determining that the action response data matches at least a threshold number of criteria of the completion criteria for at least a threshold number of actions of the one or more actions, authorize the requested travel; and
responsive to determining that the action response data does not match at least a threshold number of criteria of the completion criteria for at least a threshold number of actions of the one or more actions, deny the request to schedule travel.

2. The computing platform of claim 1, wherein the one or more actions include one or more of: modifying traveler access to a system, modifying traveler access to data, and modifying a device associated with the traveler.

3. The computing platform of claim 1, further including instructions that, when executed, cause the computing platform to:
responsive to determining that the action response data matches at least a threshold number of criteria of the completion criteria for at least a threshold number of actions of the one or more actions, automatically scheduling the requested travel.

4. The computing platform of claim 1, wherein the plurality of data sources includes data sources internal to an entity implementing the computing platform and data sources external to the entity implementing the computing platform.

5. The computing platform of claim 1, wherein the threshold number of criteria of the completion criteria includes all completion criteria.

6. The computing platform of claim 1, wherein the destination includes a geographical location.

7. The computing platform of claim 1, wherein the one or more potential threats include physical threats and cyber threats.

8. The computing platform of claim 1, wherein the one or more actions are identified using machine learning.

9. A method, comprising:
by a computing platform comprising at least one processor, memory, and a communication interface:
receiving, by the at least one processor and via the communication interface, a request to schedule travel, the request including a destination, dates of travel, and traveler data;
requesting, by the at least one processor and from a plurality of data sources, threat data, the requested threat data including data related to at least one of: the destination, dates of travel and traveler;
responsive to requesting the threat data, receiving, by the at least one processor and from the plurality of data sources, threat response data;
based on the received threat response data, the destination, dates of travel and traveler data, and using on one or more machine learning datasets, generating, by the at least one processor, one or more potential threats;
based on the generated one or more potential threats, identifying, by the at least one processor, one or more actions for completion, each action of the one or more actions including a plurality of completion criteria;
transmitting, by the at least one processor and via the communication interface, the one or more actions to one or more devices for execution;
receiving, by the at least one processor and from the one or more devices, action response data including data associated with execution of the one or more actions;
comparing, by the at least one processor, the action response data to the completion criteria for each action of the one or more actions;
if it is determined that the action response data matches at least a threshold number of criteria of the completion criteria for at least a threshold number of actions of the one or more actions, authorizing the requested travel; and
if it is determined that the action response data does not match at least a threshold number of criteria of the completion criteria for at least a threshold number of actions of the one or more actions, denying the request to schedule travel.

10. The method of claim 9, wherein the one or more actions include one or more of: modifying traveler access to a system, modifying traveler access to data, and modifying a device associated with the traveler.

11. The method of claim 9, further including:
if it is determined that the action response data matches at least a threshold number of criteria of the completion criteria for at least a threshold number of actions of the one or more actions, automatically scheduling the requested travel.

12. The method of claim 9, wherein the plurality of data sources includes data sources internal to an entity implementing the computing platform and data sources external to the entity implementing the computing platform.

13. The method of claim 9, wherein the threshold number of criteria of the completion criteria includes all completion criteria.

14. The method of claim 9, wherein the destination includes a geographical location.

15. The method of claim 9, wherein the one or more potential threats include physical threats and cyber threats.

16. The method of claim 9, wherein the one or more actions are identified using machine learning.

17. One or more non-transitory computer-readable media storing instructions that, when executed by a computing platform comprising at least one processor, memory, and a communication interface, cause the computing platform to:
receive a request to schedule travel, the request including a destination, dates of travel, and traveler data;
request, from a plurality of data sources, threat data, the requested threat data including data related to at least one of: the destination, dates of travel and traveler;
responsive to requesting threat data, receive, from the plurality of data sources, threat response data;
based on the received threat response data, the destination, dates of travel and traveler data, and using on one or more machine learning datasets, generate one or more potential threats;
based on the generated one or more potential threats, identify one or more actions for completion, each action of the one or more actions including a plurality of completion criteria;
transmit the one or more actions to one or more devices for execution;
receive, from the one or more devices, action response data including data associated with execution of the one or more actions;
compare the action response data to the completion criteria for each action of the one or more actions;
responsive to determining that the action response data matches at least a threshold number of criteria of the completion criteria for at least a threshold number of actions of the one or more actions, authorize the requested travel; and
responsive to determining that the action response data does not match at least a threshold number of criteria of the completion criteria for at least a threshold number of actions of the one or more actions, deny the request to schedule travel.

18. The one or more non-transitory computer-readable media of claim 17, wherein the one or more actions include one or more of: modifying traveler access to a system, modifying traveler access to data, and modifying a device associated with the traveler.

19. The one or more non-transitory computer-readable media of claim 17, further including instructions that, when executed, cause the computing platform to:
responsive to determining that the action response data matches at least a threshold number of criteria of the completion criteria for at least a threshold number of actions of the one or more actions, automatically scheduling the requested travel.

20. The one or more non-transitory computer-readable media of claim 17, wherein the plurality of data sources includes data sources internal to an entity implementing the computing platform and data sources external to the entity implementing the computing platform.

21. The one or more non-transitory computer-readable media of claim 17, wherein the threshold number of criteria of the completion criteria includes all completion criteria.

22. The one or more non-transitory computer-readable media of claim 17, wherein the destination includes a geographical location.

23. The one or more non-transitory computer-readable media of claim 17, wherein the one or more potential threats include physical threats and cyber threats.

24. The one or more non-transitory computer-readable media of claim 17, wherein the one or more actions are identified using machine learning.
